(19) United States
(12) Patent Application Publication
(10) Pub. No.: US 2007/0005694 A1
(43) Pub. Date: Jan. 4, 2007

(54) System and method for distributed multi-media production, sharing and low-cost mass publication

(75) Inventors: Laird Popkin, West Orange, NJ (US); Yaron Samid, New York, NY (US); Eric Lazarus, New York, NY (US)

Correspondence Address: Ryan, Mason & Lewis, LLP, Suite 205, 1300 Post Road, Fairfield, CT, 06824, US

(73) Assignee: Pando Networks, Inc.

(21) Appl. No.: 11/171,748

(22) Filed: Jun. 30, 2005

(51) Int. Cl. G06F 15/16; G06F 17/00

(52) U.S. Cl. 709/204; 715/751; 709/201

(57) ABSTRACT

A system for synchronized viewing and editing includes a media viewer/editor for viewing and editing media content connected to a peer-to-peer swarming network, a user interface for said media viewer/editor, and a communication channel connected to said user interface and to one or more other user interfaces and other media viewer/editors, wherein said media viewer/editor can transmit media content to the other viewer/editors via said peer-to-peer swarming network, and wherein said user interface can emit and receive operating information through said communication channel to each of said one or more other user interfaces to coordinate with said other media viewer/editors.

### CROSS REFERENCE TO RELATED UNITED STATES APPLICATIONS

Reference is hereby made to these inventors' copending patent applications, U.S. patent application Ser. No. ______, entitled “Method And Apparatus For Offline Cooperative File Distribution Using Cache Nodes,” filed Jun. 3, 2005, and U.S. patent application Ser. No. ______, entitled “Method And Apparatus For Cooperative File Distribution In The Presence Of Firewalls”, filed Jun. 3, 2005, the contents of both of which are incorporated herein by references in their entirety.

### FIELD OF THE INVENTION

This invention is directed to applying peer-to-peer swarming technology to instant messaging that can provide synchronized viewing and editing for a plurality of users.

### DISCUSSION OF THE RELATED ART

Several vendors supply instant messaging (IM) software including AOL, Yahoo and others. In addition, some companies supply cross-protocol IM clients including Trillian from http://www.ceruleanstudios.com/. Trillian, for example, supports AOL, Yahoo, MSN and other IM protocols. Likewise, several vendors supply Voice over IP technology including Skype.com, some of which also support desktop video conferencing.

Peer-to-peer swarming is supported by open-source initiatives including bittorrent (http://www.bittorrent.com/) as well as commercial vendors. For example, OnionNetworks (http://www.onionnetworks.com) supplies an API for swarmstreaming, the ability to do peer-to-peer swarming while prioritizing the retrieval of some bytes higher than others.

Google's Ad Words provides a way to provide context dependent advertisement on a web site which is akin to providing context-relevant advertisements to people using an IM client.

### SUMMARY OF THE INVENTION

According to an aspect of the invention, there is provided a system for synchronized viewing and editing that includes a media viewer/editor for viewing and editing media content connected to a peer-to-peer swarming network, a user interface for said media viewer/editor, and a communication channel connected to said user interface and to one or more other user interfaces and other media viewer/editors, wherein said media viewer/editor can transmit media content to the other viewer/editors via said peer-to-peer swarming network, and wherein said user interface can emit and receive operating information through said communication channel to each of said one or more other user interfaces to coordinate with said other media viewer/editors.

According to a further aspect of the invention, the communication channel is a command queue which can receive a command object from a user interface, wherein said command object incorporates a command that can change the state of a media viewer/editor, and further comprising a view/edit synchronizer that receives said command object from said command queue and transmits said command object to each of said other media viewer/editors.

According to a further aspect of the invention, the communication channel is a message oriented heartbeat queue, wherein each media viewer/editor can both publish its current state on the message oriented heartbeat queue and determine the state of at least one of the one or more other media viewer/editors from the message oriented heartbeat queue.

According to a further aspect of the invention, if the current state of a media viewer/editor is ahead of the current state of each of the other media viewer/editors by more than a predetermined amount of time, the current state of each of the other media viewer/editors can be changed to match the current state of said media viewer/editor that is ahead.

According to a further aspect of the invention, if the current state of a media viewer/editor is behind the current state of each of the other media viewer/editors by more than a predetermined amount of time, the current state of each of the other media view/editors is paused until the current state of said media viewer/editor that is behind has caught up to the current state of the other media viewer/editor.

According to a another aspect of the invention, there is provided a method for synchronized viewing and editing comprising the steps of establishing a subscriber relationship with a communication channel, receiving a signal from said communication channel, sending said signal to one or more media viewer-editors, and repeating the steps of receiving a signal and sending a signal until an exit signal is received.

According to a further aspect of the invention, the signal is a command object encapsulating a command for a media viewer/editor.

According to a further aspect of the invention, the communication channel is a queue that can receive signals from one or more user interfaces for controlling media viewer/editors.

According to a another aspect of the invention, there is provided a method for distributing information comprising the steps of compiling information regarding members of a peer-to-peer swarming network, periodically data mining the information regarding the network members to determine what categories of network members would be interested in what categories of content, soliciting from a network member, after said member receives content, the interestingness of said content and whether said member's buddies can know of said member's interest in said content, and determining those buddies of said member who would be interested in receiving said received content, and informing said member of those buddies.

According to a further aspect of the invention, determining those buddies interested in receiving content further comprises determining, for each of said member's buddies, whether said buddy is included in a category of network members who are interested in the category of said received content.

According to a further aspect of the invention, the method further comprises sending content to said interested buddies over said peer-to-peer swarming network.

According to another aspect of the invention, there is provided a system for transmitting advertisements and announcements over a network, comprising a chat client connected to a network, wherein the chat client can transmit and receive encrypted information over said network, and a trusted advertisement server connected to said chat client, capable of receiving advertisements and announcements, wherein said advertisement server can monitor the unencrypted content of the information being transmitted and received by said chat client and display an advertisement or announcement to said chat client based on the content of said information.

According to a further aspect of the invention, the trusted advertisement server resides on a same computer as said chat client.

According to a further aspect of the invention, the trusted advertisement server is connected to a peer-to-peer swarming network over which said trusted advertisement server can receive said advertisements and announcements.

According to another aspect of the inventions, there is provided a system for instant messaging over a peer-to-peer swarming network comprising an instant messaging messenger connectable to a message infrastructure, and a peer-to-peer swarming interface connectable to a peer-to-peer infrastructure, wherein said instant messaging messenger can send and receive text messages from one or more other instant messaging messengers, and said peer-to-peer swarming interface can send and receive media content from other peer-to-peer swarming interfaces.

According to a further aspect of the invention, the instant messaging messenger can send and receive audio and video messages from said one or more other instant messaging messengers.

According to a further aspect of the invention, the system further comprises a matching engine that can examine the content of an instant message and a chat conversation and compare said content against the content of an advertisement or announcement received over said peer-to-peer swarming network, and can select an advertisement or announcement for display whose content matches that of the instant message and chat conversation.

According to a further aspect of the invention, the system further comprises a media viewer/editor for displaying media content received over the peer-to-peer swarming network, said media viewer/editor further comprising a semi-transparent text overlay that comprise commands for the operations of said media viewer/editor.

According to a further aspect of the invention, the system further comprises a cache connectable to said instant messaging messenger via said message infrastructure, wherein said cache can store content being sent from said instant messaging messenger to one or more other instant messaging messengers when any of the one or more other instant messaging messengers are offline.

According to a further aspect of the invention, the system further comprises a media viewer/editor for viewing and editing media content connectable to said peer-to-peer swarming network, a user interface for said media viewer/editor, and a communication channel connected to said user interface and to one or more other user interfaces and other media viewer/editors, wherein said media viewer/editor can transmit media content to the other viewer/editors via said peer-to-peer swarming network, and wherein said user interface can emit and receive operating information through said communication channel to each of said one or more other user interfaces to coordinate with said other media viewer/editors.

According to a further aspect of the invention, the instant messaging messenger can transmit and receive encrypted information, and the system further comprises a trusted advertisement server connected to said chat client, capable of receiving advertisements and announcements, wherein said advertisement server can monitor unencrypted content of the information being transmitted and received by said chat client and display an advertisement or announcement to said chat client based on the content of said information.

In a further aspect of the invention, the system further comprises means for including an identification number to swarm enabled media content sent over said peer-to-peer network, and means for logging a message when a swarm enabled media package is received, wherein said message includes an identification number associated with said received media package and an identifier of the receiver of said media package, wherein said logged message is readable by a sender of said media package.

In another aspect of the invention, there is provided a method of joining an online community for sharing large files over a peer-to-peer swarming network, the method comprising the steps of receiving an Internet communication that includes swarm enabled media content and instructions for installing a swarm enabled client, installing said swarm enabled client, using said swarm enabled client to receive said swarm enabled media content, installing a sender of said swarm enabled media content on a buddy list, and searching incoming and outgoing Internet communications and identifying potential additions to said buddy list from the recipients and senders of said Internet communications.

In another aspect of the invention, there is provided a system for file sharing in an instant messaging network comprising an instant messaging client connectable to a message network infrastructure, and a data store connectable to said instant messaging client via said message network infrastructure, wherein said data store can store content being sent from said instant messaging client to one or more other instant messaging clients when any of the one or more other instant messaging clients are offline.

In another aspect of the invention, there is provided a system for sending a data file over a computer network comprising one or more interfaces for connecting a peer-to-peer swarming infrastructure to one or more clients that can send and receive data over said computer network, wherein each of said one or more client is associated with at least one of said interfaces, wherein each said interface can support a plurality of transfer initiation modes to allow each said client to communicate with said peer-to-peer swarming infrastructure, wherein when a first of said plurality of clients sends a data file over said network to a second of said plurality of clients, said data file is sent from said peer-to-peer swarming infrastructure to said second client.

The technology underlying the embodiments of the invention disclosed herein form the subject matter of these inventors' copending patent applications, U.S. patent application Ser. No. ______, entitled “Method And Apparatus For Offline Cooperative File Distribution Using Cache Nodes,” and U.S. patent application Ser. No. ______, entitled “Method And Apparatus For Cooperative File Distribution In The Presence Of Firewalls.

### BRIEF DESCRIPTION OF THE DRAWINGS

FIG. 1 is a use case diagram illustrating sending and joint viewing of content, according to an embodiment of the invention.

FIG. 2 is a component diagram illustrating a system for large file sharing and viewing/editing of video and other multi-media content, according to an embodiment of the invention.

FIG. 3 is a component diagram illustrating synchronized viewing and editing, according to an embodiment of the invention.

FIG. 4 is a dataflow diagram illustrating how advertisements and other announcements can be made contextually relevant without compromising the privacy of chat client users, according to an embodiment of the invention.

FIG. 5 is a flowchart illustrating a synchronized viewing/editing process that can be implemented inside of the View/Edit Synchronizer depicted in FIG. 3, according to an embodiment of the invention.

FIG. 6 is an activity diagram illustrating how a system dashboard can cause chat messages to present context-relevant advertising and announcements to a user, according to an embodiment of the invention.

FIG. 7 is a use case diagram illustrating how a user might identify other users for later communication, according to an embodiment of the invention.

FIG. 8 depicts a user interface for supporting semitransparent overlays, according to an embodiment of the invention.

FIG. 9 is a use case diagram illustrating support for sending to an offline buddy, according to an embodiment of the invention.

FIG. 10 is a flow chart illustrates a viral expert process, according to an embodiment of the invention.

FIG. 11 is a flow chart illustrating an installation process, according to an embodiment of the invention.

FIG. 12 is a structure diagram illustrating the use of a common infrastructure for several clients, according to an embodiment of the invention.

### DETAILED DESCRIPTION OF THE PREFERRED EMBODIMENTS

Terminology

Observer Pattern: A one-to-many dependency between objects so that when one object changes states, all its dependents are notified and updated automatically. The observed object can be said to “publish” information. The dependent objects, which observe, can be said to “subscribe” to the information. See: Design Patterns, Elements of Reusable Object-Oriented Software, Erich Gamma, Richard Helm, Ralph Johnson, John Vlissides, Addison Wesley, ISBN 0-201-63361-2.

Publish-Subscribe Messaging: Applications often need to propagate data changes to synchronize the state of objects in an application. In this type of application, changes to elements of the underlying information must be reflected in all the subsystems containing references to it. Publish-subscribe messaging is a way to implement the observer pattern by having sources of information put information on queue objects, which can then be monitored for updates by any number of receivers. The sources of information are said to publish, and those objects that monitor are said to subscribe.

Message Oriented Middleware (MOM): A form of software “plumbing” that connects separate systems in a network by carrying and distributing messages between them. The messages may contain data, software instructions, or both. MOM infrastructure is typically built around a queuing system that stores messages pending delivery, and that can keep track of whether and when each message has been delivered. Most MOM systems support autonomous publish-subscribe messaging. MOM products frequently use proprietary messaging technologies. Well-known examples include IBM's MQSeries, MSMQ from Microsoft, and Tibco Rendezvous, but emerging standards specifications such as Java Messaging Service (JMS) and WS-ReliableMessaging are enabling standards-based MOM infrastructures.

Command Pattern: A software development design pattern in which requests are encapsulated as objects, thereby allowing a software developer to parameterize clients with different requests, to queue or log requests, and to support undoable operations. This pattern is documented in, for example, Design Patterns, Elements of Reusable Object-Oriented Software, Erich Gamma, Richard Helm, Ralph Johnson, John Vlissides, Addison Wesley, ISBN 0-201-63361-2.

Related Content: Any two content streams where one person is viewing one stream, another person is viewing the second stream, and the streams are kept in lock step with one another. Examples include two versions of the same video with different audio tracks, one in English and another in French. Another example would be a version of a stream that de-emphasizes or leaves out nudity, violence or other emotionally charged elements inappropriate for a child to view.

Data-Enabled Software Component: A software component that gathers data and then applies one or more rules to provide a context-based result. For example, an advertisement server can obtain information about context, such as what people have been talking about during a chat session, and apply a pattern-matching algorithm to produce relevant advertisements for display. In this example, the data are the rules about what advertisements to display under what conditions, and the software, which is the interpreter that applies the rules and provides the relevant advertisements or announcements.

Buddy List: Instant messenger programs often supply a list of individuals with whom a user interacts. Users may be notified when buddies connect to the network, leave, etc. Generally, a buddy list makes it easy for users to create a group of buddies, communicate with them, delete them, and send information to them.

Transfer Initiation Mode: A data transfer mode in which data can be sent because a user sent an email, an Instant Message, deposited or retrieved a file from an FTP site or grabbed a file from a web server.

Data Mining: Data analysis based on looking for patterns. Also known as automatic knowledge discovery.

Peer-to-peer Swarming: A technology for delivering large files, such as large video files, as many digital “chunks”. A data file can in effect be stored in a peer-to-peer swarming network by being redundantly stored in those hosts that form the network. With swarming, small chunks of the file can be simultaneously downloaded from different hosts, which can include desktop computers of consumers, and re-assembled to form a whole file. This technique creates an extremely efficient “virtual large pipe” that allows content providers to allocate fewer servers and reduce dedicated network resources, thus reducing distribution and administrative costs.

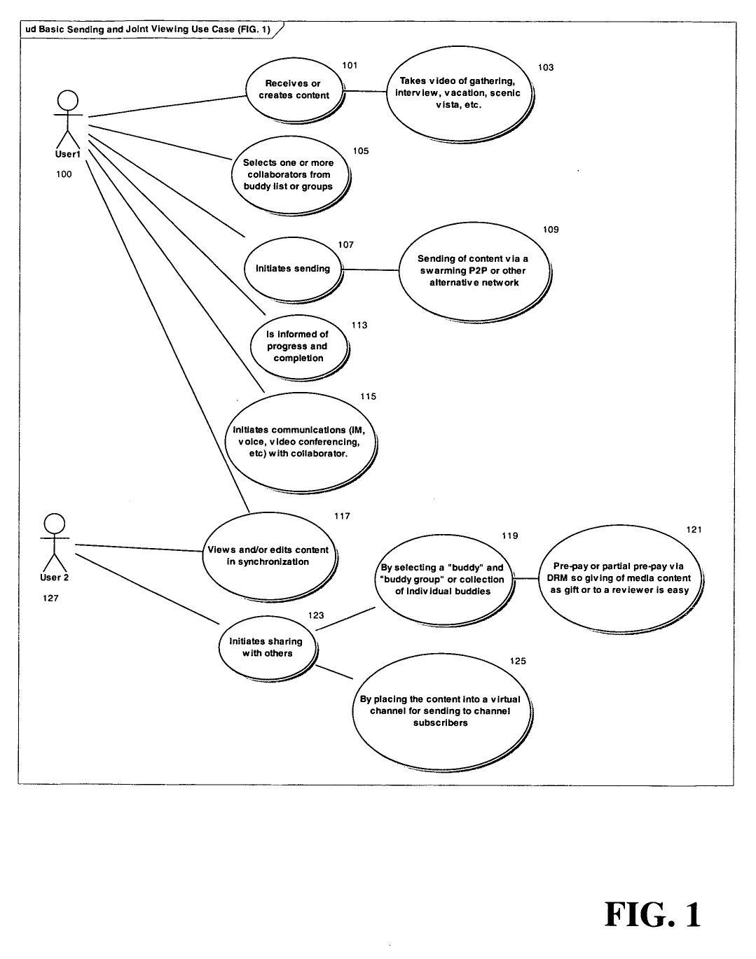

FIG. 1 is a use case diagram illustrating sending and joint viewing of content, according to an embodiment of the invention. User1 100 can create and/or receive 101 content that could be in the form of a very large file. That content could be a video file 103 that depicts a gathering, perhaps a sales meeting, an interview or some other interesting video content. User1 100 selects 105 one or more collaborators or groups of users from a buddy list. Perhaps employing drag and drop, the User1 100 initiates sending 107 of content, which could be performed by employing 109 a swarming P2P or other communication channel to a single buddy or to a collection of buddies. User1 100 is informed 113 of the progress of the transfer, potentially showing both how much data has been sent and how much has been received by User2's 127 computer.

User1 100 initiates communication via IM, voice, video conferencing, etc., with one or more collaborators 115, after which they agree to view and/or edit content in synchronization 117. Any user can add a view stream to the video application, start the viewing, stop the viewing, jump to a new location in the view streams, copy a chunk of view stream, paste a chunk of view stream into another stream, implement video effects, assign audio to a view stream, and other video and audio editing functions. When a collaborator performs any of these operations, all collaborators can see the effect of the operation. They can also see an indicator of what operation has been performed. This indicator could be in the form of an activity transcript, iconic or textual indicator superimposed on the video, button highlighting, menu-item highlighting, or audio indicator.

User2 127 can also share 123 the new or existing content with others. This could be performed by selecting 119 an individual buddy or a group and sending the content. User2 127 could place 125 some of the content into a virtual channel so that others can subscribe to the content, permitting the content to be downloaded automatically so that viewing can take place without delay.

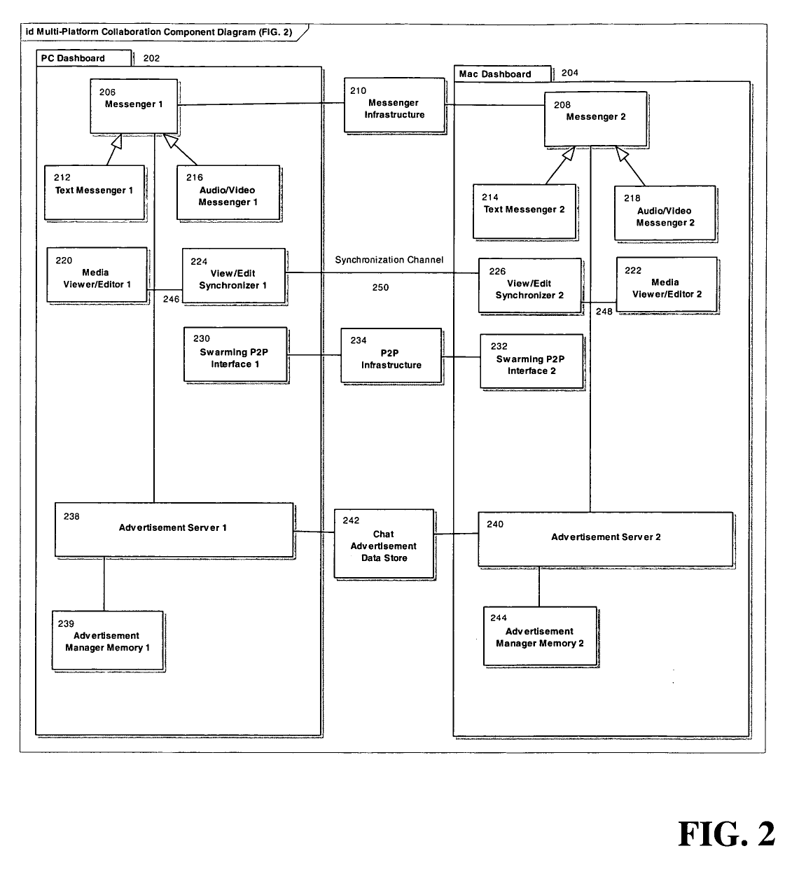

FIG. 2 is a component diagram illustrating a system for sharing large files and viewing/editing video and other multi-media content, according to an embodiment of the invention. The system Dashboard 202, 204 a program for large file sharing and viewing/editing of video and other multi-media content, can run on multiple platforms, for example, a PC system 202 and on a Macintosh system 204 with respective messengers 206, 208 allowing text, audio and video conferencing via Text Messengers 212, 214 and Audio/Video Messenger 216, 218. Text Messenger 212, 214 and Audio/Video Messenger 216, 218 communicate with each other over a Messenger Infrastructure 210, which could reside on a special server computer or server farm, or could be distributed over a computer network. The Messenger Infrastructure 210 allows clients to discover one another, and coordinates communication among the clients. Since a dashboard will often reside behind a firewall, Messenger Infrastructure 210 can be implemented in a separate machine through which messages are sent.

The Dashboard 202, 204 instances can share files via a swarming P2P Infrastructure 234, to which they can connect via swarming P2P Interface 230, 232, which can be implemented using BitTorrent or similar file-sharing technologies.

The Media Viewers Editor 220, 222 publishes user commands across a link 246, 248 to a View/Edit Synchronizer 224, 226. These commands include such operations as, begin viewing content at a particular place in a particular stream, or stop viewing content. Media Viewers Editor 220, 222 also subscribe to the View/Edit Synchronizer 224, 226 so that what other users do on remote dashboards will affect the local dashboard as if it had been performed by the local user requesting the action. View/Edit Synchronizer 224, 226 can function as a command processor. View/Edit Synchronizer 224, 226 can communicate over a Synchronization Channel 250 that implements, for example, publish-subscribe messaging.

Advertisement Servers 238, 240 obtain advertisements from Chat Advertisement Data Store 242 and delivers the most appropriate advisements to Messengers 206, 208 for display to the user. Advertisement Manager Memory 239, 244 remembers such relevant information as what advertisements have been shown to which user, how recently, if the user responded to that advertisement positively or negatively, etc., so that advertisement display can be performed intelligently based on responses to past displays of advertisements. This can be achieved employing simple rules, complex learning algorithms or anything in between.

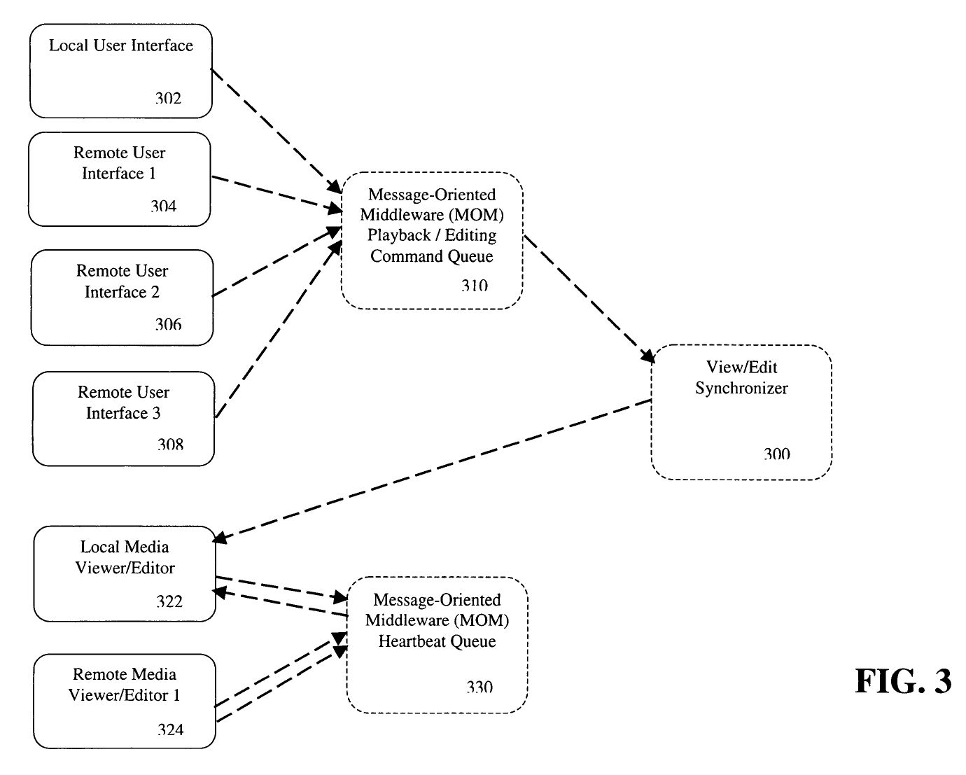

FIG. 3 is a component diagram illustrating synchronized viewing and editing, according to an embodiment of the invention. Identical or related content can be made available to a Local Media Viewer/Editor 322 program and any number of Remote Media Viewer/Editor 324 programs. This content could have been produced locally, or it could have arrived via FTP, HTTP, streaming, swarming, swarm-streaming, or some other means of transmission. The content could be video, 3D animation files, or anything else that can be displayed over time. Before synchronized viewing/editing begins, the relevant content is made available to each client via the View/Edit Synchronizer 300.

According to an embodiment of the invention, synchronized viewing and editing of content employs a command pattern and publish-and-subscribe messaging. Local User Interface 302 and Remote User Interfaces 304, 306, 308 do not directly display or modify content but generate messages referred to as command objects. A command object can be associated with any action a user can perform in the user interface. These actions include, for example, start viewing a particular content stream at a particular location, stop viewing content, copy content into another stream, and exit this synchronized shared session.

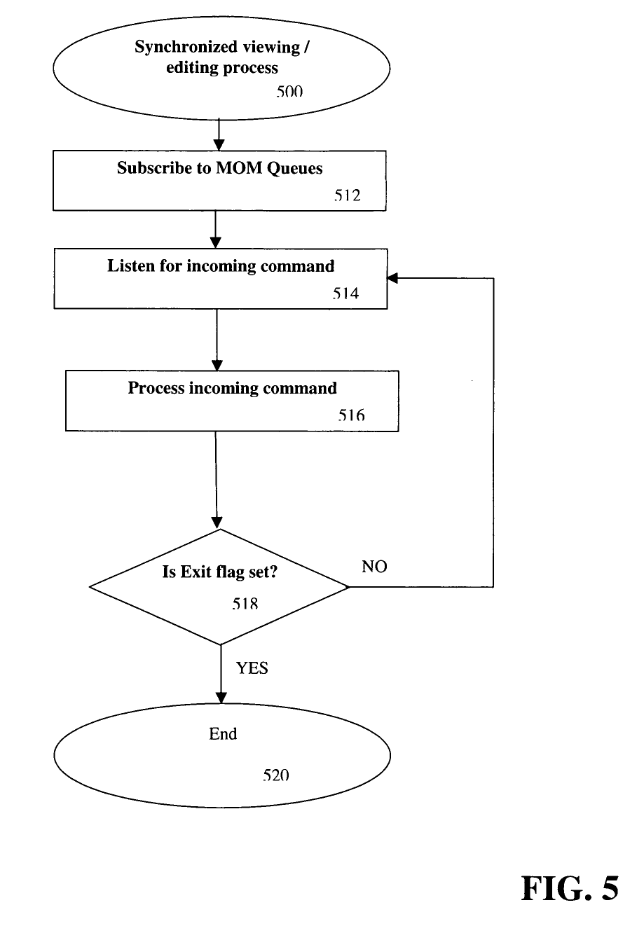

These command objects travel from the User Interfaces 302, 304, 306, 308 that create them to the Message-Oriented Middleware (MOM) Playback/Editing Command Queue 310, from which they are distributed to View/Edit Synchronizer 300, which is running on each synchronized client. When each of these Synchronized Viewing/Editing Processes 500, described below in connection with FIG. 5, starts on each of the clients, each establishes a subscriber relationship to the relevant MOM Queue 310. Thereafter, the View/Edit Synchronizer 300 waits for commands to become available and processes each one in turn, and those messages in turn act on the Local Media Viewer/Editor 322, indicating starting, stopping viewing, editing content, fast forwarding, etc.

During an extended viewing/editing session, it is possible for clients to become un-synchronized. This can be addressed in several ways. One involves having each of the Local Media Viewer/Editor 322 and Remote Media Viewer/Editors 324 publish their position in the content stream to a MOM Heartbeat Queue 330 at regular intervals. If any of them is ahead by more than some pre-set amount of time, the others can jump forward to catch up with the leader. Alternatively, everyone could pause and wait for the one that is behind to catch up.

According to another embodiment of the invention, the synchronized viewing could be performed by having each client contact the other clients and provide a status message describing what it is doing currently, e.g., playing at normal speed, two times normal speed, etc. The protocol could be designed so that it is clear which User Interface should provide direction to the others. For example, the user interface that has received the most recent user input could automatically become the leader. The contacting could be accomplished using publish and subscribe messaging, having one-to-one links such as socket connections for each pair of user interfaces, or by posting the status to a data store, such as a file or central database, which each client can poll to determine the status of each of the other user interfaces.

FIG. 5 is a flowchart illustrating a synchronized viewing/editing process that can be implemented inside of the View/Edit Synchronizer 300 depicted in FIG. 3, according to an embodiment of the invention.

A Synchronized Viewing/Editing Processes 500 can run on each client. When each of these Synchronized Viewing/Editing Processes 500 starts, each establishes 512 a subscriber relationship to the relevant MOM queues. Thereafter, each process waits 514 for commands to become available and processes 516 each one in turn. The commands are received from MOM Playback/Editing Command Queue 310 depicted in FIG. 300.

When commands are processed 516, a state change is propagated to the Local Media Viewer/Editor 322 depicted in FIG. 3. The state change can involve changing the portion of the stream of content being viewed, what stream is being viewed, if it is currently in playback, and, if so, at what speed, etc.

When one of the commands, such as an end command, sets an exit flag to true, the synchronized viewing stops at 516, and the loop is complete at 518. Thereafter viewing can continue but synchronization will no longer occur 520.

Using this approach, any number of collaborators with network access can view content in synchronization from anywhere in the world.

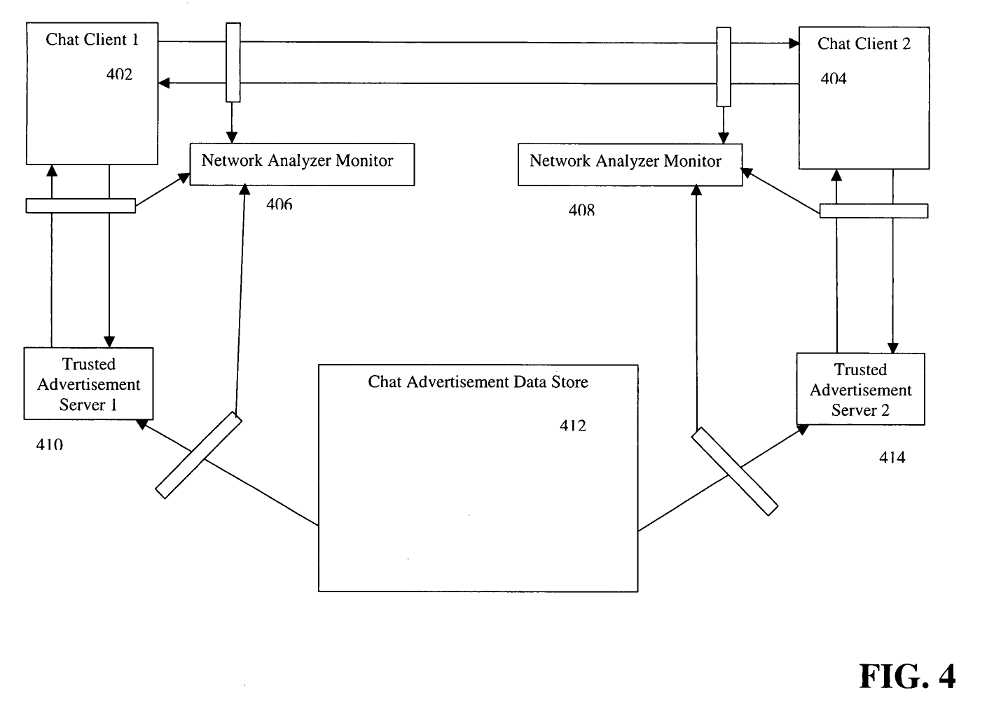

FIG. 4 is a dataflow diagram illustrating how advertisements and other announcements can be made contextually relevant without compromising the privacy of chat client users, according to an embodiment of the invention. Two Chat Clients 402, 404 are depicted communicating with one another over an encrypted channel. According to an embodiment of the invention, privacy of the conversation is respected in that the text of the conversation is shared over an encrypted connection with the conversation partners, and is not shared with any central advertisement server that could listen to the chat conversation and select advertising content based on the content of the conversation. This privacy is documented to the user, potentially with the use of a built-in Network Analyzer Monitor 406, 408.

Advertisements and patterns that describe when each advertisement should be displayed can be stored in the Chat Advertisement Data Store 412. Chat Advertisement Data Store 412 sends announcements and advertisements to a Trusted Advertisement Servers 410, 414 which are data-enabled software components. According to one embodiment of the invention, each respective Trusted Advertisement Server 410, 414 can run on the same computer as the respective Chat Client 402, 404. By sending advertisements to the individual's computer rather than sending conversation content to a central server, the risk that the privacy of that conversation could be compromised is reduced. In an alternative embodiment of the invention, the Trusted Advertisement Servers 410, 414 can be implemented be on a computer that, while not an individual's workstation, is still known to respect privacy.

The system depicted in FIG. 4 can further include built-in Network Analyzer Monitors 406, 408, which indicate to the chat client user that advertisements are coming in, but that no unencrypted content is going out. Network Analyzer Monitor 406, 408 can provide English-like explanations of the data packets that are going into and out of the Chat Client 402, 404, the Trusted Advertisement Server 410, 414, and the Chat Advertisement Data Store 412.

An additional technique to increase a user's confidence that conversations are not being monitored includes providing an explanation of a particular advertising match to an interested user. For example, the Chat Clients 402, 404 could provide inform the interested user that the reason that he or she saw this particular advertisement was that a particular matching rule specified that the first time the user types particular words in an IM to another user, this advertisement will be displayed. The Chat Clients 402, 404 could also notify the user that this rule has been present in a local file since a particular date.

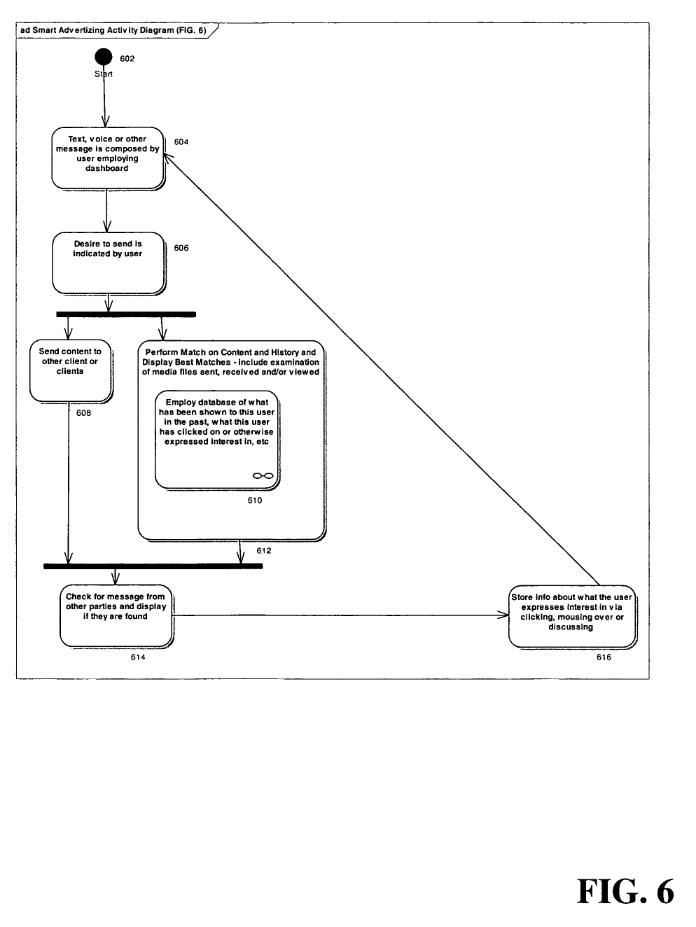

FIG. 6 is an activity diagram illustrating how a system dashboard can cause chat messages to present context-relevant advertising and announcements to a user, according to an embodiment of the invention. A user engaged in a chat conversation composes 604 text or other messages, and indicates 606 that the message is ready to be sent to another user or group of users. In parallel with the sending of the message to the other users 608, this message and other elements of the conversation are matched 612 by a matching engine against advertisements and announcements that have been received by the user. This match can involve knowing what this user has seen 610 in the way of advertisements and other messages in the past so as to avoid, for example, presenting the same material too many times. The matched advertisements and announcements are then displayed to the user. Next, the dashboard checks 614 for messages from the other chat clients and displays those. If the user clicks 616 on any advertisements or announcements or in any other way expresses interest in them, the dashboard remembers this interaction, and the user can again compose a message 604 to begin the process again.

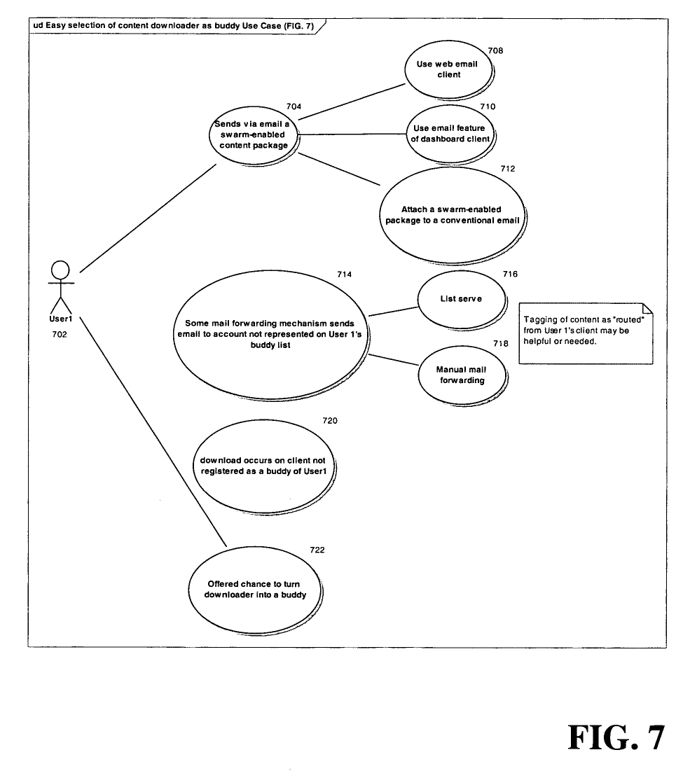

FIG. 7 is a use case diagram illustrating how a user might identify other users for later communication, according to an embodiment of the invention. User1 702 might not have a unique network address for an individual with whom he or she wants to communicate and might not have that user on a “buddy list” for easy communication. Employing either a web-email client 708, the email feature of the dashboard 710, or a conventional email program 712, User1 702 can send 704 a swarm-enabled content package.

Thereafter, the mail is forwarded 714. This forwarding could occur manually 718 because a receiver of the email clicked on the forward button and sent the swarm-enabled content package to another potentially interested party. Alternatively, a list serve or other forwarding mechanism 716 could send it to a potentially large number of interested parties. Routing information can be added either to the swarm-enabled content package itself or to some other data store.

Next, because someone else is interested in the content, a download occurs 720 on a client not registered as a buddy of User1 702. User1 702 can, thereafter, be notified that one or more network members are downloading the content from the network. If any of those members are not known buddies of User1 702, User1 702 can be, during the download or anytime thereafter, provided with an opportunity 722 to add those users as buddies, thus expanding User1's 702 personal network. Those new buddies can include people with home and work machines of whom User1 702 only knew one, friends and co-workers of the people who received User1's 702 material, and/or people who are on mailing lists whom User1 702 may want to know in the future, given their common interests. It is not unusual to know one email address for someone but not the other email addresses that that the network retains for that individual. This technique is referred to as enhanced buddy identification. Similarly, just as User1 702 can be provided with an opportunity to add the receiving user as a buddy, the receiver can be provided with an opportunity to add the sender as a buddy.

There are several techniques to ensure that a sending client of a swarm-enabled content package can determine which client programs received and/or downloaded the package. Many such clients might have received the swarm-enabled content package from another source and might be downloading it at the same time.

One exemplary, non-limiting technique to allow the sending client and receiving client to be aware of one another would be for the sender to append a unique identification number to a designated field of the swarm-enabled content package. This could be a number associated with the sender's membership in the peer-to-peer swarming network. Alternatively, the ID could be one generated specially for this purpose by the sender. This option could provide greater privacy for the sender. When the receiver receives a swarm-enabled content package, a message could be logged indicating that the receiver received the content. This log message could be directly received by the sender or, alternatively, stored in a data store such as a central database or pushed onto a MOM queue. The message could contain the ID added by the sender. The sender could arrange to be aware of such log messages. The receiver could log other information at various times, such as when it starts the actual download, when it is 10 percent done, when it has been attempting to download the content for a predetermined amount of time, etc. This would enable the sender to monitor those who received the swarm-enabled content package without also seeing those who received the package from other senders. The information log could be used to allow the sender to see a progress bar reflecting how much a particular receiver has received of the underlying content.

This “trail” of IDs can also be used to allow the receiver to find out who the sender was. This could be done if there is provided a way to turn the unique ID back into the information needed to add a buddy into a buddy list. That information could be the email address under which the client was registered In the peer-to-peer swarming network. This conversion from an ID back to buddy information could be performed via a database lookup to a server machine. The result of this database look up could be returned using public key encryption so that only the intended receiver can determine who the sender was, if privacy is desired.

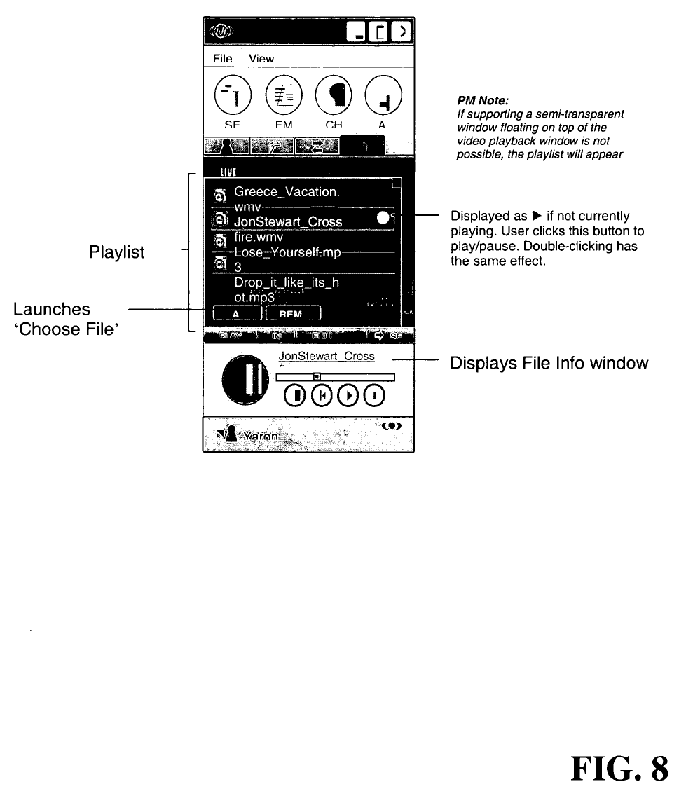

FIG. 8 depicts a user interface for supporting semitransparent overlays, according to an embodiment of the invention. This support can be a feature of the Media Viewer/Editors 220, 218 in the client program. For example, a play list or other information can be shown superimposed on top of a video or other rendering of still or moving images. The superimposed, semitransparent text can be active in that it responds to mouse clicks, dragging and other mouse actions. The text can be used to select media items to play, display the status of what is playing, and provide access to information such as who sent the file, when it was sent, when it arrived, the type of the file, the size of the file, etc.

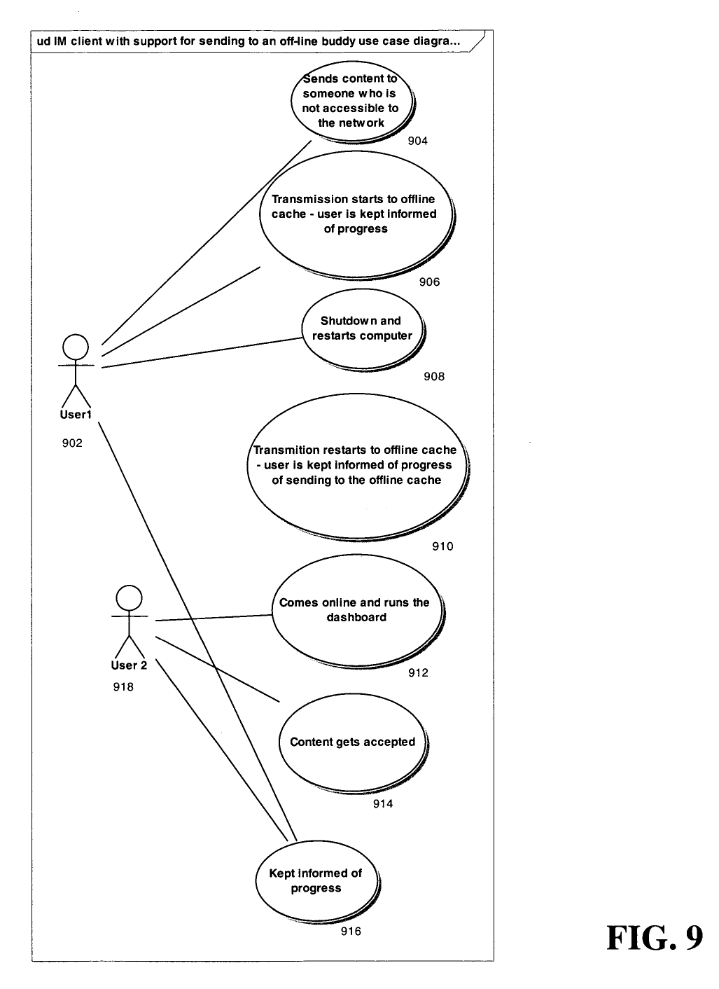

FIG. 9 is a use case diagram illustrating support for sending to an offline buddy, according to an embodiment of the invention. User1 902 sends 904 content to someone on his or her buddy list who is currently offline. Transmission 906 to an offline cache begins and User1 902 is kept informed of progress. User1 902 can work on other projects, lose the network connection and re-establish it, and even shutdown 908 and restart the entire computer during the period when the information is being transmitted from the local machine. The system software and protocols for both clients can handle such interruptions by saving relevant state information and using this information to restart a transfer 910 without human intervention. User2 918 comes online and runs the dashboard 912. User2 918 receives 914 the content. Both users are kept informed 916 of the progress. The support of sending to offline users, resiliency against interruptions, sending to multiple buddies at the same time, and of sending arbitrarily large files, makes it more likely for content to succeed in reaching large numbers of people.

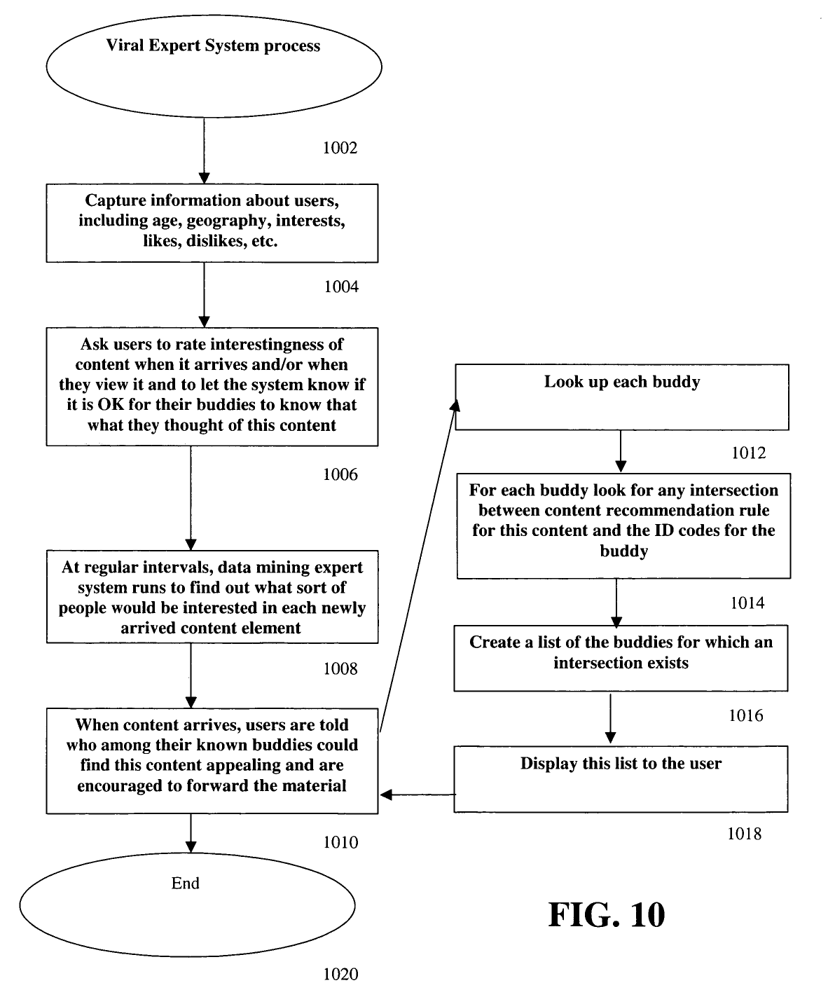

FIG. 10 is a flow chart illustrating a viral expert system process, according to an embodiment of the invention. Information, like a virus, flows though existing social networks, from friend to friend, for example. A viral expert system can assist and amplify the normal distribution of information by making relevant recommendations to a user of whom, especially among a user's buddies, might find content interesting. The dashboard can suggest via a combination of monitoring and data mining potential recipients who would find the content appealing.

A Viral Expert Process 1002 according to an embodiment of the invention repeats the following activities. Information is captured 1004 about members of a peer-to-peer file sharing network, including age, geography, interests, likes, dislikes, etc. This information can be used in data mining to observe members' preference patterns. When content is received and/or viewed, a member is asked to rate 1006 the interestingness of the content and whether their buddies can know their likes and dislikes with regard to the content. At regular intervals, a data mining expert system runs 1008 to find out what demographic categories of people would be interested in each newly arrived content element when it arrives on a particular user's dashboard. The viral expert system could determine, for example, that 80% of people who liked video X who are between the ages of 20 and 30 also like video Y. The dashboard would then point out that certain of the user's buddies are likely to value a particular content element. When such content arrives, users are told 1010 who among their known buddies might find this content appealing and are encouraged to forward the material.

In terms of the implementing step 1008, many standard data mining techniques can be used, including inferring rudimentary rules, constructing decision trees, covering constructing rules, data mining association rules, linear models, and instance-based learning. Other techniques include specifically bagging (voting, averaging), boosting, stacking (stacked generalizations), and meta-learning.

Data mining expert system 1008 can generate identification codes (IDs) that represent subsets of the membership base. One code, for example code “98776,” could mean “all women born between 1960 and 1975 who liked video X and disliked video Y”. Users of a file-sharing network could then be tagged with a collection of these numbers. A recommendation could be a collection of IDs of those users who the system thinks would have special interest in the content.

The encouragement step 1010 can be implemented in different ways. According to one embodiment of the invention, when content arrives, users can be quickly told who would be interested by performing an intersection between the sets of IDs for everyone on the buddy list against those on the recommendations list. The recommendation lookup can be performed by looking up 1012 each buddy, doing an intersection computation 1014, and retaining those buddies for whom there is an intersection 1016. Then that list is displayed 1018 as the buddies who might want to know about this content. After the user is told about the recommendation, the process completes 1020.

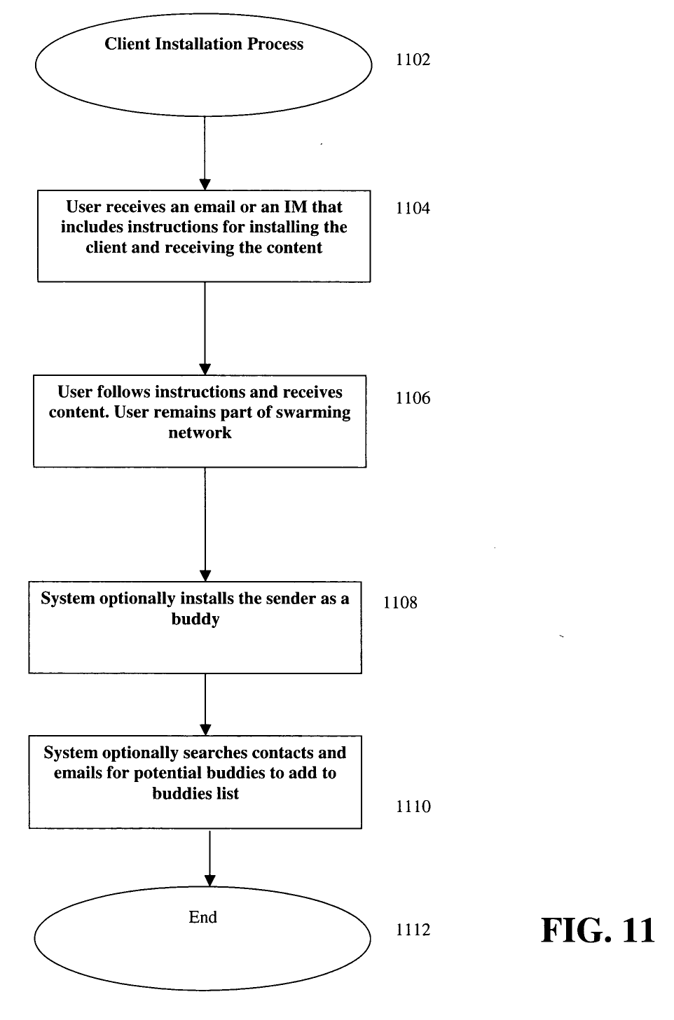

FIG. 11 is a flow chart illustrating an installation process, according to an embodiment of the invention. This installation process enables the installer to join an online community for sharing large files over a peer-to-peer swarming network. The Client Installation Process 1102 begins with an email being sent 1104 that includes both a swarm-enabled content package and instructions for installation of the client. Alternately the content could arrive via an instant message (IM). If the process starts with an IM, the content and the instructions for installation could both be accessible via a Universal Resource Locator (URL). Alternatively, the swarm-enabled content package could be stored on a server and accessed via the URL.

A user follows 1106 instructions to install and start up the client and to receive content. The user should remain part of the swarming network. The system optionally installs 1108 the sender as a buddy. The system also optionally searches 1110 contacts and emails that have been sent or received for potential buddies to add to a buddies list, and completes 1112 the installation process. If the user employs a rich-client email solution such as Outlook, it is easy to search the user's incoming and outgoing emails for email addresses, as well as their contacts. The swarming network can have many of these individuals already registered as users of the network. These people can become buddies with the click of a button, simply by asking for authorization from the user.

Although the illustrative embodiments have been described herein with reference to the accompanying drawings, it is to be understood that the present invention and method are not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

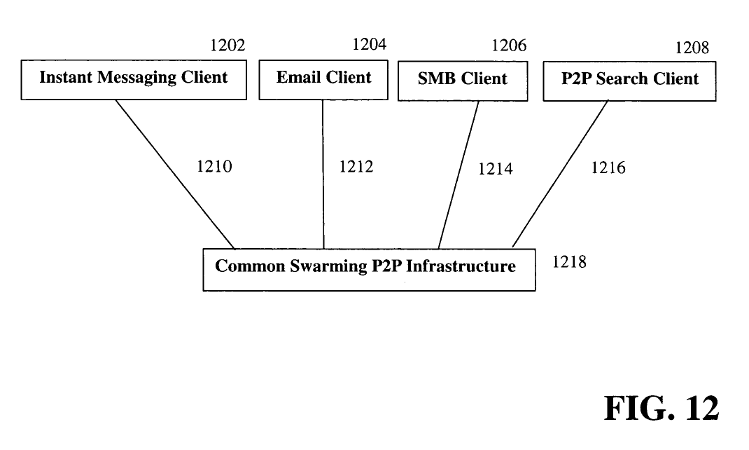

FIG. 12 is a structure diagram illustrating the use of a common infrastructure for several clients, according to an embodiment of the invention. An Instant Messaging Client 1202 can send and receive data via a specialized interface 1210. An Email Client 1204 can send and receive data via a specialized interface 1212. A Server Message Block (SMB) Client or other file server clients 1206 can send and receive data via a specialized interface 1214. A P2P Search Client 1208, such as a peer-to-peer swarming client like Limeware, can send and receive data via a specialized interface 1216. Each of these clients supplies a distinct transfer initiation mode for the end user of that client. The interfaces 1210, 1212, 1214 and 1216 are are adapted to allow the client programs 1202, 1204, 1206, 1208 to use an underlying Common Swarming P2P Infrastructure 1218. In addition, each interface 1210, 1212, 1214 and 1216 can support a plurality of transfer initiation modes.

These client programs 1202, 1204, 1206, 1208 are exemplary and non-limiting, and other clients can employ the same Common Swarming P2P Infrastructure 1218 as well. A Common Swarming P2P Infrastructure 1218 enables a file that is being transferred via one transfer initiation mode to benefit from transfer via another transfer initiation mode because the swarming occurs via clients who have received that file from other transfer initiation modes. For example, a large attachment file F could be shared via Instant Messaging Client 1202 initially with a group of IM buddies. One of those buddies might then email the file F to another person via an Email Client 1204. The receiver of that email might well get the file F from some combination of the initial sender, the IM receivers, and anyone else to whom the initial sender or IM receivers transferred the file using any of the client programs 1202, 1204, 1206, 1208.

These client programs 1202, 1204, 1206, 1208 could be either existing or newly constructed programs. Common Swarming P2P Infrastructures 1218 are freely available for use by individuals ordinarily skilled in the art. Non-limiting examples of such interfaces include the bittorrent (http://www.bittorrent.com/) API and the JTilla (http://itella.sourceforge.net/) package for interfacing to a GNUTella network which allow, among other things, for a local data store to become part of the wider virtual data store provided by the swarming infrastructure.

The methods and apparatus of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described with reference to a specific embodiment, this description is not meant to be construed in a limiting sense. Various modifications of the disclosed embodiment as well as alternative embodiments of the invention will become apparent to one skilled in the art upon reference to the description of the invention. It is therefore contemplated that the appended claims will cover any such modifications of embodiments that fall within the true scope of the invention.

What is claimed is:

1. A system for synchronized viewing and editing, comprising:
a media viewer/editor for viewing and editing media content connected to a peer-to-peer swarming network;
a user interface for said media viewer/editor; and
a communication channel connected to said user interface and to one or more other user interfaces and other media viewer/editors, wherein said media viewer/editor can transmit media content to the other viewer/editors via said peer-to-peer swarming network, and wherein said user interface can emit and receive operating information through said communication channel to each of said one or more other user interfaces to coordinate with said other media viewer/editors.

2. The system of claim 1, wherein said communication channel is a command queue which can receive a command object from a user interface, wherein said command object incorporates a command that can change the state of a media viewer/editor, and further comprising a view/edit synchronizer that receives said command object from said command queue and transmits said command object to each of said other media viewer/editors.

3. The system of claim 1, wherein said communication channel is a message oriented heartbeat queue, wherein each media viewer/editor can both publish its current state on the message oriented heartbeat queue and determine the state of at least one of the one or more other media viewer/editors from the message oriented heartbeat queue.

4. The system of claim 3, wherein if the current state of a media viewer/editor is ahead of the current state of each of the other media viewer/editors by more than a predetermined amount of time, the current state of each of the other media viewer/editors can be changed to match the current state of said media viewer/editor that is ahead.

5. The system of claim 3, wherein if the current state of a media viewer/editor is behind the current state of each of the other media viewer/editors by more than a predetermined amount of time, the current state of each of the other media view/editors is paused until the current state of said media viewer/editor that is behind has caught up to the current state of the other media viewer/editor.

6. A method for synchronized viewing and editing, said method comprising the steps of:
establishing a subscriber relationship with a communication channel;
receiving a signal from said communication channel;
sending said signal to one or more media viewer-editors; and
repeating the steps of receiving a signal and sending a signal until an exit signal is received.

7. The method of claim 6, wherein said signal is a command object encapsulating a command for a media viewer/editor.

8. The method of claim 6, wherein said communication channel is a queue that can receive signals from one or more user interfaces for controlling media viewer/editors.

9. A method for distributing information comprising the steps of:
compiling information regarding members of a peer-to-peer swarming network;
periodically data mining the information regarding the network members to determine what categories of network members would be interested in what categories of content;
soliciting from a network member, after said member receives content, the interestingness of said content and whether said member's buddies can know of said member's interest in said content; and
determining those buddies of said member who would be interested in receiving said received content, and informing said member of those buddies.

10. The method of claim 9, wherein determining those buddies interested in receiving content further comprises determining, for each of said member's buddies, whether said buddy is included in a category of network members who are interested in the category of said received content.

11. The method of claim 9, further comprising sending content to said interested buddies over said peer-to-peer swarming network.

12. A system for transmitting advertisements and announcements over a network, comprising:
a chat client connected to a network, wherein the chat client can transmit and receive encrypted information over said network; and
a trusted advertisement server connected to said chat client, capable of receiving advertisements and announcements, wherein said advertisement server can monitor the unencrypted content of the information being transmitted and received by said chat client and display an advertisement or announcement to said chat client based on the content of said information.

13. The system of claim 12, wherein said trusted advertisement server resides on a same computer as said chat client.

14. The system of claim 12, wherein said trusted advertisement server is connected to a peer-to-peer swarming network over which said trusted advertisement server can receive said advertisements and announcements.

15. A system for instant messaging over a peer-to-peer swarming network comprising:
an instant messaging messenger connectable to a message infrastructure; and
peer-to-peer swarming interface connectable to a peer-to-peer infrastructure, wherein said instant messaging messenger can send and receive text messages from one or more other instant messaging messengers, and said peer-to-peer swarming interface can send and receive swarm enabled media content from other peer-to-peer swarming interfaces.

16. The system of claim 15, wherein said instant messaging messenger can send and receive audio and video messages from said one or more other instant messaging messengers.

17. The system of claim 16, further comprising a matching engine that can examine the content of an instant message and a chat conversation and compare said content against the content of an advertisement or announcement received over said peer-to-peer swarming network, and can select an advertisement or announcement for display whose content matches that of the instant message and chat conversation.

18. The system of claim 15, further comprising a media viewer/editor for displaying media content received over the peer-to-peer swarming network, said media viewer/editor further comprising a semi-transparent text overlay that comprise commands for the operations of said media viewer/editor.

19. The system of claim 15, further comprising a cache connectable to said instant messaging messenger via said message infrastructure, wherein said cache can store content being sent from said instant messaging messenger to one or more other instant messaging messengers when any of the one or more other instant messaging messengers are offline.

20. The system of claim 15, further comprising:
a media viewer/editor for viewing and editing media content connectable to said peer-to-peer swarming network;
a user interface for said media viewer/editor; and
a communication channel connected to said user interface and to one or more other user interfaces and other media viewer/editors, wherein said media viewer/editor can transmit media content to the other viewer/editors via said peer-to-peer swarming network, and wherein said user interface can emit and receive operating information through said communication channel to each of said one or more other user interfaces to coordinate with said other media viewer/editors.

21. The system of claim 15, wherein said instant messaging messenger can transmit and receive encrypted information; and further comprising
a trusted advertisement server connected to said chat client, capable of receiving advertisements and announcements, wherein said advertisement server can monitor unencrypted content of the information being transmitted and received by said chat client and display an advertisement or announcement to said chat client based on the content of said information.

22. The system of claim 15, further comprising means for including an identification number to swarm enabled media content sent over said peer-to-peer network, and means for logging a message when a swarm enabled media package is received, wherein said message includes an identification number associated with said received media package and an identifier of the receiver of said media package, wherein said logged message is readable by a sender of said media package.

23. A method of joining an online community for sharing large files over a peer-to-peer swarming network comprising the steps of:
receiving an Internet communication that includes swarm enabled media content and instructions for installing a swarm enabled client;
installing said swarm enabled client;
using said swarm enabled client to receive said swarm enabled media content;
installing a sender of said swarm enabled media content on a buddy list; and
searching incoming and outgoing Internet communications and identifying potential additions to said buddy list from the recipients and senders of said Internet communications.

24. A system for file sharing in an instant messaging network comprising:
an instant messaging client connectable to a message network infrastructure; and
a data store connectable to said instant messaging client via said message network infrastructure, wherein said data store can store content being sent from said instant messaging client to one or more other instant messaging clients when any of the one or more other instant messaging clients are offline.

25. A system for sending a data file over a computer network comprising:
one or more interfaces for connecting a peer-to-peer swarming infrastructure to one or more clients that can send and receive data over said computer network, wherein each of said one or more client is associated with at least one of said interfaces, wherein each said interface can support a plurality of transfer initiation modes to allow each said client to communicate with said peer-to-peer swarming infrastructure, wherein when a first of said plurality of clients sends a data file over said network to a second of said plurality of clients, said data file is sent from said peer-to-peer swarming infrastructure to said second client.

26. A program storage device readable by a computer, tangibly embodying a program of instructions executable by the computer to perform the method steps for synchronized viewing and editing, said method comprising the steps of:
establishing a subscriber relationship with a communication channel;
receiving a signal from said communication channel;
sending said signal to one or more media viewer-editors; and
repeating the steps of receiving a signal and sending a signal until an exit signal is received.

27. The computer readable program storage device of claim 26, wherein said signal is a command object encapsulating a command for a media viewer/editor.

28. The computer readable program storage device of claim 26, wherein said communication channel is a queue that can receive signals from one or more user interfaces for controlling media viewer/editors.

29. A program storage device readable by a computer, tangibly embodying a program of instructions executable by the computer to perform the method steps for distributing information comprising the steps of:
compiling information regarding members of a peer-to-peer swarming network;
periodically data mining the information regarding the network members to determine what categories of network members would be interested in what categories of content;
soliciting from a network member, after said member receives content, the interestingness of said content and whether said member's buddies can know of said member's interest in said content; and
determining those buddies of said member who would be interested in receiving said received content, and informing said member of those buddies.

30. The computer readable program storage device of claim 29, wherein determining those buddies interested in receiving content further comprises determining, for each of said member's buddies, whether said buddy is included in a category of network members who are interested in the category of said received content.

31. The computer readable program storage device of claim 29, further comprising sending content to said interested buddies over said peer-to-peer swarming network.

32. A program storage device readable by a computer, tangibly embodying a program of instructions executable by the computer to perform the method steps for joining an online community for sharing large files over a peer-to-peer swarming network comprising the steps of:
receiving an Internet communication that includes swarm enabled media content and instructions for installing a swarm enabled client;
installing said swarm enabled client;
using said swarm enabled client to receive said swarm enabled media content;
installing a sender of said swarm enabled media content on a buddy list; and
searching incoming and outgoing Internet communications and identifying potential additions to said buddy list from the recipients and senders of said Internet communications.
